(19) United States
(12) Patent Application Publication
(10) Pub. No.: US 2009/0074581 A1
(43) Pub. Date: Mar. 19, 2009

(54) VERTICAL-AXIS WIND TURBINE

(76) Inventor: Alain Burlot, Phalempin (FR)

Correspondence Address: LADAS & PARRY LLP, 224 SOUTH MICHIGAN AVENUE, SUITE 1600, CHICAGO, IL, 60604, US

(21) Appl. No.: 11/719,570

(22) PCT Filed: Nov. 17, 2005
(86) PCT No.: PCT/FR05/02859

§ 371 Date: Aug. 16, 2007

(30) Foreign Application Priority Data
Nov. 18, 2004 (FR) 0412262

(51) Int. Cl. F03D 3/06; F03D 3/00; F03D 5/00; F03D 9/00

(52) U.S. Cl. 416/204 R; 416/223 R; 290/55

(57) ABSTRACT

A vertical-axis wind power plant employed especially for supplying electricity, pumping water or for storing potential energy. More precisely, the wind power plant of the invention comprises at least two blades attached by their respective lower ends to a rotating supporting step of a tower. Each of the blades is likewise attached by its upper end to the rotating supporting step of the tower by means of a rigid lever supported on this tower and attached to this rotating supporting step.

The present invention relates to a vertical-axis wind power plant and is employed especially for supplying electricity, pumping water or for storing potential energy.

These days, the energy wind power plant appears as an important alternative to traditional energy sources. Contrary to these traditional sources, it is renewable and non-polluting in terms of gaseous emissions and waste in the atmosphere or on land.

The development of this energy has accelerated recently. This progression has been accompanied by an evolution in reliability, size and yield of wind power plants, causing a progressive drop in kilowatt-hour production costs to a competitive level, relative to other sources of energy.

Wind power plants are generally classified in two large families: vertical-axis wind power plants, and the horizontal-axis wind power plants.

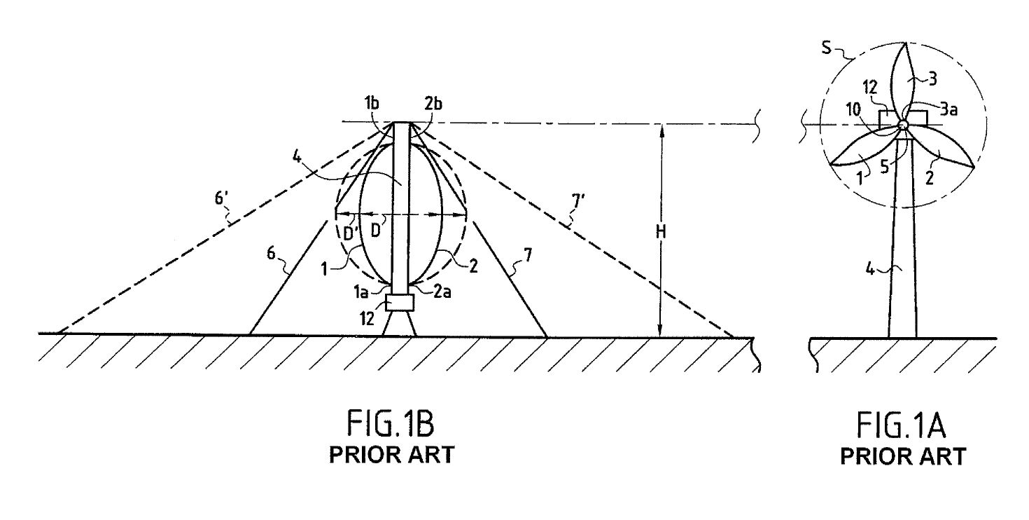

The horizontal-axis wind power plant, an example of which is illustrated in FIG. 1a, is probably the best-known and most widely used type of wind power plant. This type of wind power plant generally comprises three blades 1, 2, 3, fixed by one 1a, 2a, 3a of their two ends at the same single point 5 of a vertical tower, or a tower 4. These blades 1, 2, 3 drive a horizontal axis in rotation, which is connected to an alternator or generator in a drive device 12, or nacelle. This type of wind power plant is considered to be the direct descendent of windmills, of which it can be said that the wooden sails are replaced by aircraft wings.

The height H of the tower 4 has an influence on the power since strong winds blow at height. The length of the blades 1, 2, 3 likewise influences the power, since these blades delimit the surface S of the swept disc of air and since the power supplied is proportional to this surface S.

One of the disadvantages of this type of wind power plant is that maintenance becomes complicated and dangerous, since the nacelle 12 is located at the top of the tower 4. A second major disadvantage is that a horizontal-axis wind power plant is unidirectional. It accordingly requires an orientation device, with a motor, so as to modify this orientation as a function of the direction of the wind. This orientation device is generally integrated into the nacelle 12, or associated therewith, therefore at the top of the tower 4. In addition, this type of wind power plant generates a noise disturbance, essentially tied to the speed of attack of the air disc by the blades and the coaxial thrust.

The vertical-axis wind power plant, an example of which is illustrated in FIG. 1b, has to date remained much less widely used. Its motion principle is similar to that of an anemometer: utilisation of a couple motor to drive an electrical generator or a mechanical device such as a pump.

The example illustrated in FIG. 1b, better known as a wind power plant of <<Darrieus>> type, comprises two (or three) blades 1, 2 fixed at their ends 1a, 2a and 1b, 2b respectively at the same low single point and the same single high point of the vertical tower, or tower, 4. The resulting rotor is parabolic, but it can also be cylindrical or truncated.

The height H of the tower 4, here again, influences the power since strong winds are high and the upper ends 1b, 2b of the blades 1, 2 cannot rise higher than the top of the tower 4. At a constant height H, the length of the blades 1, 2 and their curve likewise influences the power, since these blades delimit the surface S of the cylinder or of the flow of swept air and since the power is proportional to this surface S.

The advantage of this type of wind power plant, relative to horizontal-axis wind power plants, is especially to allow easier maintenance, since all the motors are at ground level, or close to the ground, in the drive device 12 which comprises inter alia the energy generator. In addition, at even power, the noise disturbance is reduced. Also, this type of wind power plant is omnidirectional, and therefore requires no electronic control for orientation.

Such vertical-axis wind power plants do however have a certain number of major disadvantages, in part the origin of the fact that these wind power plants are less widely used than horizontal-axis wind power plants. In particular, this type of wind power plant does not start up on its own since its intrinsic function causes rotation of the blades 1, 2. A launching system therefore proves necessary, but complicates installation, operation, and maintenance of this type of wind power plant.

In addition, this type of wind power plant requires using stays or guy wires 6, 7, starting from the top of the tower, to keep the assembly on the ground. For major wind power plants, the surface occupied at ground level by the cable bracing therefore becomes very consequential. In fact, the guy wires 6, 7 considerably limit the equatorial diameter, therefore the swept surface, and thus the power. Now, at a constant tower height H, to obtain a swept surface substantially equivalent to that swept by the horizontal-axis wind power plant of FIG. 1a, it is necessary to increase the length and curve of the blades 1, 2, so as to augment the equatorial diameter for it to pass from D to D′. But to do this, the cable bracing has to be spread out, as illustrated by the guy wires 6′, 7′, resulting in a very large surface occupied at ground level.

Likewise, the fact that the rotor of such a wind power plant is installed near ground level, where, naturally, the wind speed is weaker than at height and the perturbations and variations more frequent, signifies that energy capture is done in a less favourable zone. This significantly reduces the efficacy of the device.

Finally, as already mentioned, the swept surface, and therefore the power, remain limited since this surface depends inter alia on the height of the blades. The height of the blades is limited by the height of the tower, and the height of the tower is limited by regulations.

There is therefore a need for a reliable and simple solution eliminating the abovementioned disadvantages. So, it is the object of the present invention to propose a vertical-axis wind power plant, based on the <<Darrieus>> type, which has a higher output, especially by increasing the height of the blades without increasing the height of the tower, with a reduced setting-up surface at ground level, not requiring electronic startup, and with easy maintenance.

To this end, the vertical-axis wind power plant of the invention comprises blades attached to the tower only at a single low point. Accordingly, at even tower height, the blades can rise much higher than with a state-of-the-art wind power plant, the consequence of which is capturing even stronger winds, a substantial swept surface, and therefore better output. In addition, each high end of the blades is attached at the same single low point of the tower, by means of a rigid lever. These levers are supported on the tower, thus taking up the force applied by strong winds at the top of the blades to transmit it downwards, to the level of a rotating supporting step. This reduces the effect of shear, eliminating the need for stays or guy wires, and dispensing with a startup mechanism, since the wind power plant starts on its own.

The invention therefore relates to a vertical-axis wind power plant comprising at least two blades attached at their respective lower ends to a rotating supporting step of a tower.

The wind power plant is characteristic in that each of the blades is likewise attached by its upper end to the rotating supporting step of the tower by means of a rigid lever supported on this tower and attached to this rotating supporting step.

In a first variant embodiment, the link between the rigid lever and the rotating supporting step is made by the top of this rotating supporting step.

In a second variant embodiment, the link between the rigid lever and the rotating supporting step is made by the bottom of this rotating supporting step.

In another variant embodiment, optionally in combination with any one of the preceding, the length of the blades is greater than the length of the levers.

In another variant embodiment, optionally in combination with any one of the preceding, the distance between the rotating supporting step and the top of the tower is less than the distance between the top of the tower and the projection of the upper ends of the blades on the vertical axis of the tower.

This distance is preferably less than a third of the distance between the top of the tower and the projection of the upper ends of the blades on the vertical axis of the tower.

In another variant embodiment, optionally in combination with any one of the preceding, the distance between the rotating supporting step and the projection of the upper ends of the blades on the vertical axis of the tower is more than double the height of the tower.

Optionally, the equatorial diameter is greater than the height of the tower. This equatorial diameter is preferably three times more than the height of the tower.

In another variant embodiment, optionally in combination with any one of the preceding, the wind power plant of the invention comprises a first and a second electromagnetic element located respectively above and below the rotating supporting step, and electric power means adjustable in polarity and in intensity to electrically supply these electromagnetic elements.

The vertical-axis wind power plant of the invention advantageously and in particular yields a higher output, due especially to the swept surface and to the omnidirectional character. It likewise offers greater safety, due especially to the double attachment point of the blades and to maintenance of the machines being completed at ground level. The wind power plant of the invention is also more silent and therefore reduces any noise disturbance.

Other characteristics and advantages of the invention will emerge more clearly completely from the following description of the preferred embodiment variants of the device, which are given by way of non-limiting examples and in reference to the following attached diagrams:

FIGS. 1a, 1b: illustrate schematically and respectively two wind power plants of the prior art,

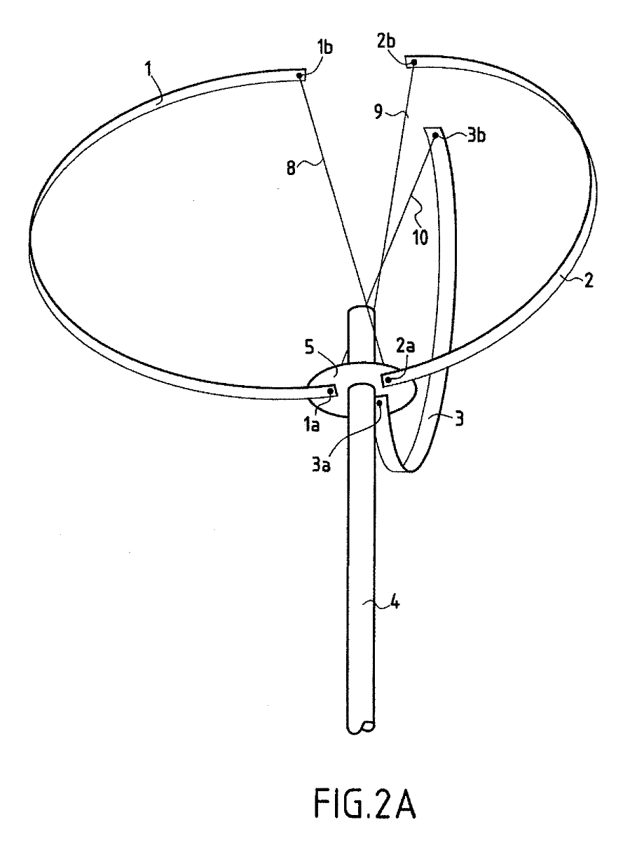

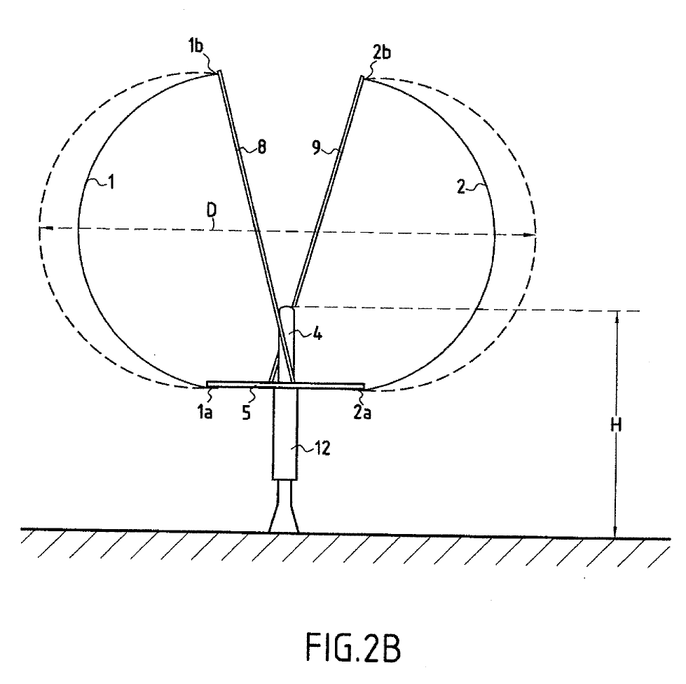

FIGS. 2a, 2b: schematically illustrate an exemplary embodiment of a wind power plant of the invention in two respective views in three dimensions and projected in two dimensions,

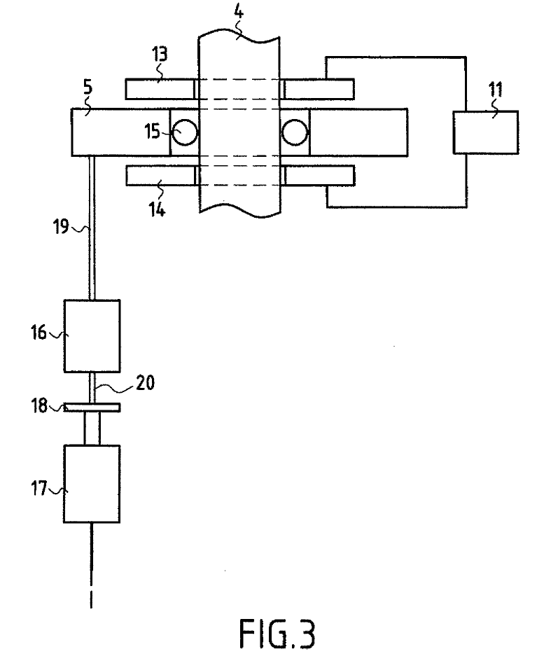

FIG. 3: schematically illustrates part of the drive device of the wind power plant of the invention.

FIGS. 1a and 1b illustrate schematically and respectively a horizontal-axis wind power plant of the prior art and a vertical-axis wind power plant of the prior art, and have been described previously.

FIGS. 2a and 2b schematically illustrate an exemplary embodiment of the wind power plant of the invention.

In FIG. 2a, the wind power plant is illustrated in a three-dimensional view. It comprises a vertical tower, or tower 4, of a height H, and a rotating supporting step 5. Attached by their respective lower ends 1a, 2a, 3a to this rotating supporting step 5 are three blades 1, 2, 3.

The rotating supporting step 5 further supports three rigid levers 8, 9, 10, preferably metallic, which are attached respectively to the three upper ends 1b, 2b, 3b of the three blades 1, 2, 3.

The levers 8, 9, 10 rest on the tower 4, thus allowing the force applied by the strong winds at the top of the blades to be taken up to be transmitted downwards. The wind power plant can therefore start up on its own.

In this embodiment, the wind power plant therefore comprises three blades, but it could also comprise two only, or again more than three. Of course, in the case of a dual-blade wind power plant, such blades are arranged in the same plane as the vertical rotation axis.

In FIG. 2b, the wind power plant of FIG. 2a is illustrated in a view projected in two dimensions. Thus, the third blade 3 is not visible, as a result of simplification and to facilitate comprehension of the sketch.

FIG. 2b consequently shows the same elements as those present in FIG. 2a, with the exception of the blade 3 and the associated lever 10.

In this variant embodiment (FIG. 2a or 2b), the link between each lever 8, 9, 10 with the rotating supporting step 5 is made by the top of this supporting step. Alternatively, this link can be made from underneath.

In this FIG. 2b the drive device 12 is likewise illustrated, whereof part will be explained in greater detail in reference to FIG. 3.

The wind power plant illustrated in FIG. 2b, or more precisely its rotor, therefore has a consequent equatorial diameter D and a sweeping surface S.

It can be stated, by comparison with FIGS. 1a and 1b, that at a constant tower height H the swept surface S is much greater. In an embodiment, the ratio between the surface swept by the wind power plant of the invention, and the surface swept by one of the wind power plants of the prior art (FIGS. 1a and 1b), constant tower height H, is at least equal to seven.

It is evident that the length of the blades 1, 2 is far greater than the length of the levers 8, 9. The resulting curve of the blades reaches a high value for the equatorial diameter, without increasing the height H of the tower.

The equatorial diameter D is preferably greater than the height of the tower 4.

In a variant embodiment, the equatorial diameter D is more than three times the height of the tower 4.

More preferably, to allow the rotor to reach a significant height with the aim of capturing stronger winds at height, the rotating supporting step 5 is situated near the top of the tower 4. In this way, the lower ends 1a, 2a of the blades 1, 2 are likewise situated near the top of the tower 4, and the upper ends 1b, 2b of these blades 1, 2 can rise to a significant height.

In a variant embodiment, the distance between the rotating supporting step 5 and the top of the tower 4 is less than the distance between the top of the tower 4 and the projection of the upper ends 1b, 2b of the blades 1, 2 on the vertical axis of the tower 4 (or axis of rotation).

In another variant embodiment, this distance between the rotating supporting step 5 and the top of the tower 4 is less than a third of the distance between the top of the tower 4 and the projection of the upper ends 1b, 2b of the blades 1, 2 on the vertical axis of the tower 4 (or axis of rotation).

In another variant embodiment, optionally in combination with any one of more of the preceding, the distance between the rotating supporting step 5 and the projection of the upper ends 1b, 2b of the blades 1, 2 on the vertical axis of the tower 4, or axis of rotation, is more than double the height of the tower 4.

Accordingly, in an embodiment, at a constant tower height H, the rotor reaches a height at least three times greater than the height reached by the rotor of any one of the wind power plants of the prior art (FIGS. 1a and 1b).

FIG. 3 schematically illustrates part of the drive device 12 of the wind power plant of the invention.

In conventional terms, the rotating supporting step 5, which rotates about the tower 4 to which it is attached by bearings 15, is attached to a multiplier 16 by means of a primary shaft 19. This multiplier 16 is attached to a generator, or alternator, 17 by means of a secondary shaft 20. Arranged between the multiplier 16 and the generator 17 is a brake 18.

This description with separation of the different elements of the drive device 12 is purely functional and is given by way of indication. For example, the multiplier 16 could very well be integrated into the generator or alternator 17, as is the case in certain types of known drive devices.

Characteristically, two electromagnetic elements 13, 14 are arranged around the tower 4, respectively above and below the rotating supporting step 5. These can be for example electromagnetic bobbins which play the role of regulator of the rotation speed of the slow shaft, as well as complementary brake for greater safety.

These electromagnetic elements 13, 14 are powered by electrical power means 11 adjustable in polarity and intensity. Appropriate regulating and/or control progressively attracts one or the other of the electromagnetic elements 13, 14 to the rotating supporting step 5.

These elements 13, 14, provided for example with a brake disc, enable electromagnetic braking, which comes as a complement to classic braking on the secondary shaft 20, such as described hereinabove. These elements therefore enable an additional safety mechanism to be operated.

The entire description hereinabove is given by way of example and does not limit the invention.

1. A vertical-axis wind power plant comprising at least two blades attached by their respective lower ends to a rotating supporting step of a tower, wherein each of said blades is likewise attached by its upper end to said rotating supporting step of said tower by means of a rigid lever supported on said tower and attached to said rotating supporting step.

2. The wind power plant as claimed in claim 1, wherein the link between said rigid lever and said rotating supporting step is made from above said rotating supporting step.

3. The wind power plant as claimed in claim 1, wherein the link between said rigid lever and said rotating supporting step is made from underneath said rotating supporting step.

4. The wind power plant as claimed in claim 1, wherein the length of said blades is greater than the length of said levers.

5. The wind power plant as claimed in claim 1, wherein the distance between said rotating supporting step and the top of said tower is less than the distance between the top of said tower and the projection of said upper ends of said blades on the vertical axis of said tower.

6. The wind power plant as claimed in claim 5, wherein the distance between said rotating supporting step and the top of said tower is less than a third of the distance between the top of said tower and the projection of said upper ends of said blades on the vertical axis of said tower.

7. The wind power plant as claimed in claim 1, wherein the distance between said rotating supporting step and the projection of said upper ends of said blades on the vertical axis of said tower is more than double the height of said tower.

8. The wind power plant as claimed in claim 1, that wherein its equatorial diameter is greater than the height of said tower.

9. The wind power plant as claimed in claim 8, wherein its equatorial diameter is more than three times the height of said tower.

10. The wind power plant as claimed in claim 1, further comprising a drive device, in turn comprising a first and a second electromagnetic element situated respectively above and below said rotating supporting step, and electric power means adjustable in polarity and intensity for powering said electromagnetic elements.
